(19) United States
(12) Patent Application Publication
(10) Pub. No.: US 2005/0266869 A1
(43) Pub. Date: Dec. 1, 2005

(54) Apparatus and method for establishing talk session in push to talk (PTT) service providing system

(75) Inventor: Yeon-Hee Jung, Suwon-si (KR)

Correspondence Address: ROYLANCE, ABRAMS, BERDO & GOODMAN, L.L.P., 1300 19TH STREET, N.W., SUITE 600, WASHINGTON,, DC, 20036, US

(73) Assignee: Samsung Electronics Co., Ltd.

(21) Appl. No.: 11/140,292

(22) Filed: May 31, 2005

(30) Foreign Application Priority Data
Jun. 1, 2004 (KR) 2004-39836

(51) Int. Cl. H04B 7/00

(52) U.S. Cl. 455/518

(57) ABSTRACT

An apparatus and method for providing a push to talk (PTT) service are provided. In a system providing the PTT service, when a called terminal receiving a talk request message from a calling terminal is in a log-out state or a busy state, a short message is transmitted to a called terminal to indicate that the talk request message is received, such that the called terminal participates in a pre-established talk session on the PTT system through the short message. The PTT system also stores address and GLMS subscriber information of a called terminal to which the short message will be sent, and unique information of the established talk session, and allows the called terminal to promptly participate in the pre-established talk session based on address information of a terminal transmitting the talk request message and destination information.

### CROSS-REFERENCE TO RELATED APPLICATION

This application claims the benefit under 35 U.S.C. §119(a) of an application for APPARATUS AND METHOD FOR ESTABLISHING TALK SESSION IN PUSH TO TALK (PTT) SERVICE PROVIDING SYSTEM, filed in the Korean Intellectual Property Office on 1 Jun. 2004 and assigned Serial No. 2004-39836, the entire contents of which are incorporated herein by reference.

### BACKGROUND OF THE INVENTION

1. Field of the Invention

The present invention relates to an apparatus and method for establishing a talk session in a push to talk (PTT) service providing system. More particularly, the present invention relates to an apparatus and method for establishing a talk session in a PTT service providing system, in which a short message containing information about an established talk session is sent to a called terminal when the called terminal is in a log-out or busy state, such that the called terminal recognizes the reception of a talk request message and participates in the established talk session.

2. Description of the Related Art

Today, the development of wired/wireless networks and voice communication services has led to an increasing concern regarding higher quality voice communication services.

For example, there are increasing concerns about a push to talk (PTT)-based voice communication service.

A PTT service refers to an instant messenger service, which is similar to a “walky-talky” service, in which a subscriber is allowed to promptly talk while pushing a terminal talk switch, providing a relatively fast communication service compared to a typical mobile communication service.

Further, when the PTT service is made among subscribers in a group, several subscribers can listen to, through their terminals, one subscriber who talks while pushing the terminal talk switch.

FIG. 1 is an overall network block diagram of a conventional PTT service providing system.

As shown in FIG. 1, the PTT service providing system includes a number of terminals 11 and 12, a number of packet data serving nodes (PDSNs) 31 and 32, a number of base station systems 21 and 22, and a PTT system 40.

The terminals 11 and 12 present in service cells of the respective base station systems 21 and 22 receive signals from the base station systems 21 and 22, and wirelessly transmit a voice or data signal input by subscribers to the corresponding base station systems 21 and 22.

The respective base station systems 21 and 22 transmit the signal from the terminals 11 and 12 in the corresponding service cells to PDSNs 31 and 32 connected to the wired network, and wirelessly transmit the signal from PDSNs 31 and 32 to the terminals 11 and 12 in the corresponding service cell.

In other words, the respective base station systems 21 and 22 assign or release wireless channels for the terminals 11 and 12 included in the service cell and guarantee the mobility of the terminals 11 and 12 through hand-off.

The base station systems 21 and 22 also convert analog signals from the terminals 11 and 12 included in the service cell to digital signals for transmission through an E1/T1 line, and transmit the digital signals to the PDSNs 31 and 32 connected to the wired network. Also, the base station systems 21 and 22 convert digital signals from the PDSNs 31 and 32 to analog signals for wireless transmission to the terminals 11 and 12 and transmit the analog signals to the terminals 11 and 12.

The respective PDSNs 31 and 32 also convert the digital signals received over the wired network to IP packets for transmission over an IP network and IP packets received from the IP network to digital signals for transmission over the wired network, and transmit them to the respective base station systems 21 and 22.

This network, which includes the terminals 11 and 12 included in the service cells of the base station systems 21 and 22 and the PDSNs 31 and 32 connected to the base station systems 21 and 22 over the wired network, is called an access network (AN).

FIG. 1 shows the system providing the PTT service among the number of terminals 11 and 12. When the PTT service is provided among a number of terminals, the access network (AN) may include a number of base station systems and a number of PDSNs, which correspond to the number of terminals.

The PTT system 40 parses IP packets received from the PDSNs 31 and 32, establishes a talk session between the terminals 11 and 12, and provides the PTT service.

Hereinafter, a method of providing a PTT service will be briefly described with reference to FIG. 1.

When a subscriber wants to establish a talk session with the second terminal 12 using the first terminal 11 and receive a voice communication service, the first terminal 11 generates a talk request signal and transmits it to the first base station system 21.

The first base station system 21 converts an analog talk request signal, which is received from the first terminal 11, to a digital talk request signal and transmits the digital talk request signal to the first PDSN 31. In response to receiving the talk request signal, the first PDSN 31 transmits a talk request message in the form of an IP packet to the PTT system 40.

The PTT system 40 recognizes the address information of a called terminal from the received talk request message and checks a connection state of the called second terminal 12. That is, the PTT system 40 checks the connection state of the second terminal 12.

When the connection state of the called second terminal 12 is a log-in state, the PTT system 40 transmits the talk request message to the second PDSN 32. The second PDSN 32 converts the talk request message in the form of an IP packet into a digital talk request signal and transmits the request signal to the second base station system 22.

The second base station system 22 converts the digital talk request signal into an analog talk request signal and transmits the analog talk request signal to the second terminal 12.

When the PTT system 40 receives a response message to the talk request message from the second terminal 12, it establishes a talk session between the first terminal 11 and the second terminal 12 and provides a PTT-based voice talk service.

This typical PTT service providing method has limited voice communication service depending on the connection state of the called terminal.

For example, when the second terminal 12 is in a log-in state and a busy state in which the second terminal 12 currently establishes a talk session with another terminal and receives a voice communication service or is in a log-out state where the second terminal 12 is not connected to the PTT system 40, it is impossible to transmit a talk request message from the first terminal 11 to the second terminal 12 and hence this case is handled as a connection error, thereby degrading service quality.

The second terminal 12 is also unable to confirm whether it is receiving a talk request signal from another terminal when it is in a log-out state in which it is not connected to the PTT system 40 or is in a busy state.

This problem occurs when there is a talk request to a called terminal (A) in a log-out or busy state. The problem will be discussed according to the following talk operating characteristics of the PTT service.

(1) In a one to one talk manner (instant personal call), this case is handled as an incoming failure with respect to a talk request signal transmitted to the called terminal (A), thereby releasing a talk session. The called terminal (A) subscriber cannot recognize a received talk request.

(2) In a one to many talk manner (instant group call), this case is also handled as an incoming failure, a group call is established between terminals in an idle state except for a called terminal (A) in a log-out state or a busy state, because a called terminal (A) subscriber cannot recognize a received talk request.

When the called terminal (A) transmits the talk request signal to a group for which a group call is established, this case is handled as being busy or a group call is established with terminals that do not participate in the established group call.

(3) In an adhoc group call, the case is handled as an incoming failure and a group call is established between idle terminals.

In this case, the called terminal (A) subscriber does not recognize a received talk request.

### SUMMARY OF THE INVENTION

Accordingly, the present invention has been made to solve the aforementioned problems. It is an object of the present invention to provide an apparatus and method for establishing a talk session in a PTT service providing system, capable of enabling a called terminal to confirm that there is a talk request from a calling terminal and to participate in an established group call, even when the called terminal to which a talk request signal will be sent is in a log-out state or a busy state.

According to an aspect of the present invention, there is provided a system for providing a push to talk (PTT) service comprising a PTT system for managing a connection state of at least one terminal connected to the PTT system, establishing a talk session based on destination information in a talk request message received from a first terminal, and providing a short message service (SMS) request message according to unique information of a second terminal participating in the talk session and unique information of the talk session when the second terminal is in a log-out state or a busy-state; and an SMS system for transmitting a short message to the second called terminal, the short message comprising the unique information of the talk session in the SMS request message received from the PTT system.

According to another aspect of the present invention, there is provided a push to talk (PTT) system for providing a PTT service to at least one terminal, the system comprising a first server for managing information about connection states of the respective terminals connecting to the first server over an access network; at least one second server for receiving a talk request message from each of the terminals, confirming a connection state of a called terminal through the first server in response to the talk request message, and then transmitting a virtual response message according to the connection state of the called terminal, a third server for managing address information of the respective terminals connecting to the second server for each list or group and managing information about whether the talk request message from each terminal is accepted; and a fourth server for establishing a talk session in response to the talk request message received via the second server, and when the virtual response message is received from the second server, requesting a short message server to transmit a short message comprising unique information of the talk session, based on the address information of the called terminal managed by the third server and the information about whether the talk request message is accepted.

According to still another aspect of the present invention, there is provided a terminal for receiving a push to talk (PTT) service, the terminal comprising a communication network interface for receiving a short message via a mobile communication network; a wireless interface for receiving a talk request message via an access network or wirelessly transmitting a talk request message generated by the terminal; and a talk processor for recognizing unique information of a talk session included in the short message received by the communication network interface, and generating a talk request message including the unique information as destination information to transmit the talk request message to the access network via the wireless interface according to a subscriber's selection.

According to yet another aspect of the present invention, there is provided a method for providing a push to talk (PTT) service in a PTT service providing system having at least one terminal, a PTT system and a short message service (SMS) system, the method comprising the steps of managing, by the PTT system, connection states of respective terminals connecting to the PTT system over a network; establishing, by the PTT system, a talk session having unique information assigned thereto in response to a received talk request message from each of the terminals, and confirming a connection state of a called terminal based on called information in the talk request message; transmitting, by the PTT system, an SMS request message to the SMS system according to unique information regarding the talk session and address information of the called terminal when the called terminal is in a log-out state or a busy-state; transmitting, by the SMS system, a short message containing the unique information to the called terminal in response to the SMS request message; transmitting, by the called terminal, a talk request message having the unique information, contained in the short message, set as destination information to the PTT system in response to a subscriber's selection; and allowing, by the PTT system, the terminal to participate in a talk session based on unique information set as destination information in the talk request message.

According to yet another aspect of the present invention, there is provided a method of providing a push to talk (PTT) service in a PTT system connected to at least one terminal, comprising the steps of managing connection states of the respective terminals connecting over an access network; establishing a talk session having unique information assigned thereto in response to a received talk request message from a first terminal; confirming a connection state of a second terminal, and transmitting a short message based on the unique information and address information of the second terminal to the second terminal via a short message server when the connection state is a service unavailable state; storing unique information of the talk session and address information of respective terminals that will participate in the talk session; and when calling address information in the talk request 15 message received from the second terminal is retrieved from stored terminal address information, allowing the second terminal to participate in a talk session corresponding to the address information.

According to yet another aspect of the present invention, there is provided a method of providing a push to talk (PTT) service in a terminal, the method comprising the steps of recognizing unique information of a talk session that is contained in a short message received from a mobile communication network; generating a talk request message having the unique information set as destination information in response to a subscriber's selection; transmitting the talk request message to a PTT system over an access network; and providing the PTT service to the subscriber over a talk session, participation in the talk session being made by the PTT system based on unique information in the talk request message.

### BRIEF DESCRIPTION OF THE DRAWINGS

A more complete appreciation of the invention, and many of the attendant advantages thereof, will be readily apparent as the same becomes better understood by reference to the following detailed description when considered in conjunction with the accompanying drawings, in which like reference symbols indicate the same or similar components, wherein:

FIG. 1 is an overall network block diagram of a conventional push to talk (PTT) service providing system;

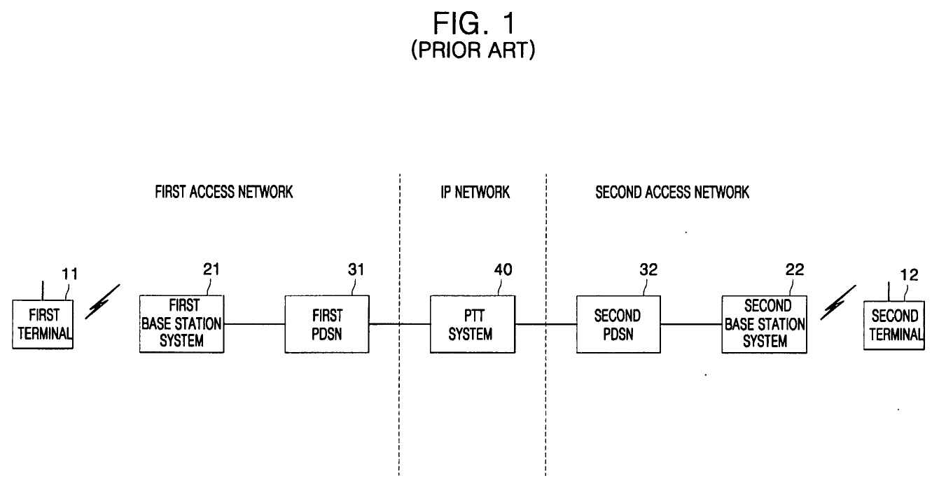

FIG. 2 is an overall block diagram of a PTT service providing system according to an embodiment of the present invention;

FIG. 3 is an internal block diagram of a terminal according to an embodiment of the present invention;

FIG. 4 is a flowchart illustrating a flow of a short message transmission according to an embodiment of the present invention; and

FIG. 5 is a flowchart illustrating a method by which a terminal participates in a talk session according to an embodiment of the present invention.

Throughout the drawings, it should be understood that like reference numbers refer to like features, structures, and elements

### DETAILED DESCRIPTION OF EXEMPLARY EMBODIMENTS

Hereinafter, an apparatus and method for establishing a talk session in a push to talk (PTT) service providing system according to an embodiment of the present invention will be described with reference to the accompanying drawings.

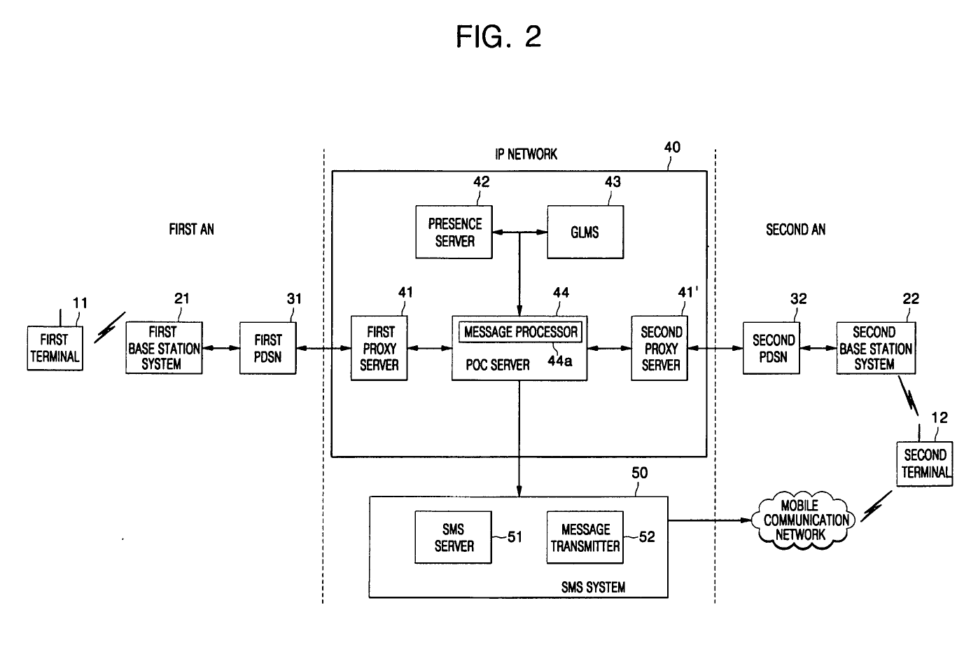

FIG. 2 is an overall block diagram of a PTT service providing system according to an embodiment of the present invention.

Referring to FIG. 2, a PTT system 40 is connected to a short message service (SMS) system 50 over an IP network.

Further, an access network (AN) includes terminals 11 and 12, base station systems 21 and 22, and PDSNs 31 and 32.

The PTT system 40 comprises a number of proxy servers 41 and 41′, a presence server 42, a group list management sever (GLMS) 43, and a PPT over cellular server (PoC) 44. The PoC server 44 includes a message processor 44a.

The SMS system 50 includes an SMS server 51 and a message transmitter 52.

The presence server 42 of the PTT system 40 manages the connection states of terminals 11 and 12 that are connected to the PTT system 50.

That is, the presence server 42 manages information about current connection states, such as log-in, log-out, idle and busy states, of the terminals 11 and 12 that connect to the PTT system 40 and are approved to receive the PTT service, and provides current connection state information of the terminals 11 and 12 in response to a state request message received from the proxy servers 41 and 41′.

The GLMS 43 manages address information of the called terminal set by subscribers of the respective terminals 11 and 12 in the form of a list or a group.

For example, the GLMS 43 may manage address information of another terminal registered by the subscriber of the first terminal 11 in the form of a list, manage address information for each group set by the subscriber, or manage address information for each talk session each time a talk session is established according to subscriber settings.

Further, when the GLMS 43 receives an address request message requesting address information of a called terminal from the PoC server 44, the GLMS 43 provides relevant terminal address information to the PoC server 44.

The address information of the respective terminals 11 and 12 managed by the GLMS 43 may be E-mail address type information, bit information corresponding to the E-mail address information, and user uniform resource identifier (URI) type information. When the GLMS 43 receives an address request message from the PoC server 44, it provides E-mail address information of the terminal, bit information or user URI type information.

Further, the GLMS 43 manages approval information set by respective subscribers, for example, overall-approval information for receiving all talk request messages by the first terminal 11 subscriber, partial-approval information for refusing a talk request message from a terminal with specific address information, overall-refusal information for refusing all talk request messages, and the like.

The GLMS 43 also manages code division multiple access (CDMA) network ID information (MDN) of respective subscribers, and upon receipt of an address information request message, provides the address information and the CDMA network ID information together.

When the proxy servers 41 and 41′ receive IP packets from the PDSNs 31 and 32 connected to the wired network and receive a talk request message via the PDSNs 31 and 32 from the terminals 11 and 12, the proxy servers 41 and 41′ recognize a connection state of the called terminal from the presence server 42. When the connection state of the called terminal is an idle state, the proxy servers 41 and 41′ transmit the talk request message to the PDSNs 31 and 32 included in the access network (AN) to the called terminal so that a talk session is established between the called terminal and the calling terminal.

Meanwhile, when the connection state of the called terminal is not an idle state but a busy state or a log-out state, the proxy servers 41 and 41′ do not transmit a talk request message to the called terminal via the PDSNs 31 and 32 but transmit a virtual response message to the talk request message, to the PoC server 44.

The proxy servers 41 and 41′ may include a message processor (not shown) that transmits the virtual response message according to the connection state of the called terminal, and have a program therein by which a manufacturer or a manager transmits the virtual response message in a software manner.

Upon receipt of the talk request message from the proxy servers 41 and 41′, the PoC server 44 confirms approval information for the called terminal managed by the GLMS 43, and transmits the talk request message to the called terminal via the proxy servers 41 and 41′ connected to the called terminal when the relevant called terminal is set to receive the talk request message from the calling terminal.

When the called terminal sets address information of the calling terminal as partial-approval information or overall-refusal information, the PoC server 44 handles it as an incoming failure.

When the talk request message received from the calling terminal comprises information indicating that there are a number of destination terminals, for instance, when the calling terminal transmits a talk request message to establish a talk session with the number of terminals, the PoC server 44 transmits talk request signals to the respective terminals via the proxy servers 41 and 41′ connected to the respective terminals according to the number of the terminals.

That is, the PoC server 44 transmits talk request messages to the number of called terminals via the respective proxy servers 41 and 41′ by the number of the called terminal addresses indicated by the received talk request message.

Meanwhile, when the message processor 44a of the PoC server 44 receives the virtual response message from the proxy servers 41 and 41′, it generates an SMS request message based on the called terminal address information and ID information of the established talk session and transmits the SMS request message via the IP network to the SMS system 50.

The message processor 44a assigns unique ID information to the talk session that is established according to the talk request message from the calling terminal, transmits the address request message to the GLMS 43, and generates an SMS request message based on the CDMA network ID information that is the called terminal address information received from GLMS 43 and the ID information of the assigned talk session.

Upon receipt of the talk request message from the calling terminal, the message processor 44a assigns unique ID information to the relevant talk session.

Further, the message processor 44a transmits the SMS request message, and stores and manages the address information of the called terminal, which has transmitted the SMS request message, and unique information of the talk session in which the called terminal is to participate.

The SMS server 51 of the SMS system 50 generates a short message based on the CDMA network ID information and the talk session unique information contained in the SMS request message from the PTT system 40, and transmits the short message to the message transmitter 52.

The message transmitter 52 transmits the received short message to the second terminal 12, which is the called terminal, over the mobile communication network.

Meanwhile, when the message processor 44a of the PPT system 40 receives the talk request message from the second terminal 12 that is the called terminal, the message processor 44a recognizes the unique information of the talk session contained in the talk request message and allows the second terminal to participate in the talk session.

The second terminal 12 may generate the talk request message containing the unique ID information of the talk session, contained in the received short message, as the destination information and transmit the talk request message to the PTT system 40.

Since the destination information indicated by the received talk request message is the ID information of the pre-established talk session, the PTT system 40 enables the second terminal 12 to participate in the set talk session.

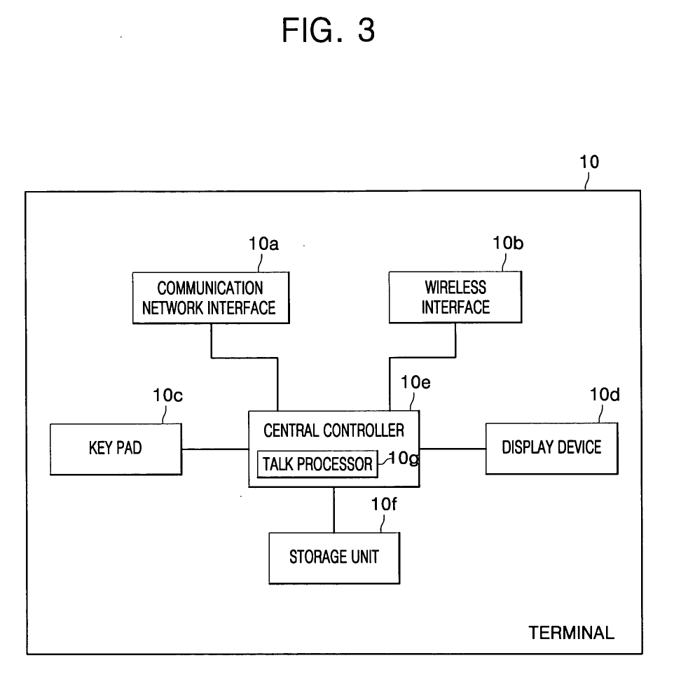

FIG. 3 is an internal block diagram of a terminal according to a preferred embodiment of the present invention.

Referring to FIG. 3, the terminal 10 according to an embodiment of the present invention comprises a communication network interface 10a, a wireless interface 10b, a central controller 10e, a key pad 10c, a display device 10d, and a storage unit 10f. The central controller 10e preferably includes a talk processor 10g.

The communication network interface 10a provides a short message from the SMS system 50 to the central controller 10e over the mobile communication network.

The communication network interface 10a provides the talk request signal, which is received over the mobile communication network, to the central controller 10e, and transmits a response signal from the central controller 10e to another terminal over the mobile communication network, such that a subscriber is provided with a voice communication service over the mobile communication network.

Further, the wireless interface 10b provides the signal from the base station systems 21 and 22 of the access network (AN) to the central controller 10e and transmits a signal from the central controller 10e to the base station systems 21 and 22.

The central controller 10e provides a display signal based on the short information in the short message received over the communication network interface 10a, to the display device 10d and stores talk session ID information contained in the short message into the storage unit 10f.

When the central controller 10e receives the short message over the mobile communication network, it outputs visual and or audible information via an output means (not shown) from which the subscriber can recognize the reception of the short message.

The display device 10d displays the short information according to the display signal provided by the central controller 10e.

The key pad 10c provides a key input signal to the central controller 10e in response to a subscriber's selection.

In response to the key input signal received from the key pad 10c, the talk processor 10g of the central controller 10e generates a talk request signal based on the talk session ID information stored in the storage unit 10f and transmits the talk request signal to the base station systems 21 and 22 of the access network.

In other words, the talk processor 10g generates a talk request message containing the talk session ID information from the storage unit 10f as the destination information, and transmits the talk request message to the proxy servers 41 and 41′ connected to the network.

When the central controller 10e transmits the talk request message and then the PTT system 40 establishes a talk session or allows the called terminal to participate in the pre-established talk session, the central controller 10e outputs voice information based on the voice signal from another terminal and transmits the voice signal based on voice information input from the subscriber to another terminal, so that the subscriber is provided with the PTT service.

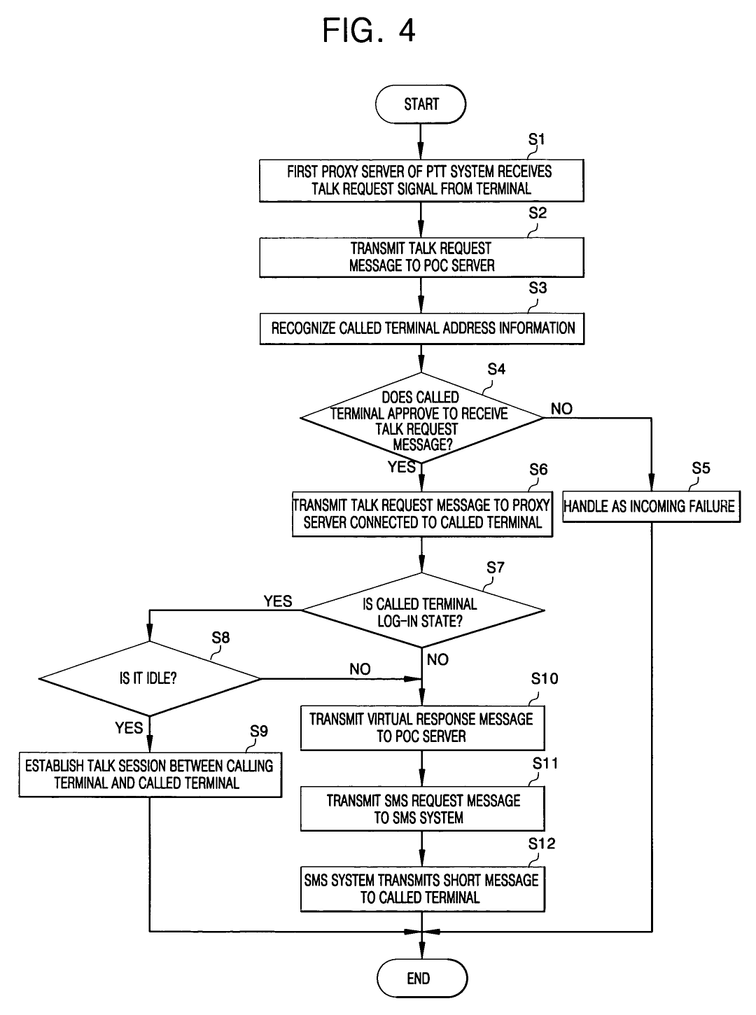

FIG. 4 is a flowchart illustrating a flow of a short message transmission according to an embodiment of the present invention.

Although the case where the first terminal 11 is transmitting a talk request message to the second terminal 12 will be described with reference to FIG. 4, the same applies to cases where the first terminal 11 transmits a talk request message to each group managed by the GLMS 43 or transmits an ad-hoc-based talk request message.

The first terminal 11 generates a talk request signal based on address information of the second terminal 12 and transmits the talk request signal to the first proxy server 41 (S1).

In this case, the first terminal 11 generates the talk request signal based on the address information of the second terminal 12 with which the first terminal 11 wants to talk, and transmits the talk request signal to the first base station system 21. The first base station system 21 converts the analog talk request signal to a digital talk request signal and transmits the digital talk request signal to the first PDSN 31.

The first PDSN 31 converts the talk request signal to a talk request message as an IP packet and transmits the talk request message to the first proxy server 41.

Further, the PTT service providing system may use a message, based on a session initiation protocol (SIP), which is a voice over IP (VoIP) protocol, as a signaling message for establishing a talk session.

That is, the first terminal 11 generates an ‘INVITE’ message that is an SIP talk request message and transmits the ‘INVITE’ message to the first proxy server 41.

The first proxy server 41 transmits the ‘INVITE’ message from the first terminal 11 to the PoC server 44 (S2).

When the PoC server 44 receives the ‘INVITE’ message, it recognizes the called terminal address information, such as destination information (S3).

The PoC server 44 also confirms the called terminal approval information managed by the GLMS 43 to check whether it is approved that the called terminal receives a talk request message from the first terminal 11 (S4).

When approval information of the respective called terminal is set as partial-approval information or overall-refusal information with respect to the address information of the first terminal 11, the PoC server 44 handles this case as an incoming failure (S5).

On the other hand, when it is approved that the second terminal 12, which is the called terminal, receives the talk request message from the first terminal 11, the PoC server 44 transmits the ‘INVITE’ message to the second proxy server 41′ connected to the second terminal 12 (S6).

In this case, when there are a number of destination terminal addresses in the INVITE message, for instance, when there are a number of called terminals, the PoC server 44 transmits an ‘INVITE’ message to respective proxy servers to which the respective called terminals are connected.

The second proxy server 41′, which is connected to the second terminal 12 as the called terminal, transmits a state request message to the presence server 42 to request connection state information of the second terminal 12.

When the presence server 42 receives the state request message from the second proxy server 41′, it transmits a response message containing the connection state information of the second terminal 12 to the second proxy server.

The second proxy server 41′ confirms that the connection state of the second terminal 12 included in the response message is a log-in state (S7), and when it is a log-in state, confirms whether it is an idle state (S8).

When the second terminal 12 is idle, the second proxy server 41 transmits an INVITE message as a talk request message to the second terminal 12 and transmits a response message from the second terminal 12 to the PoC server 44.

The PoC server 44 establishes a talk session between the first terminal 11 and the second terminal 12 (S9).

At this time, when the destination information in the ‘INVITE’ message received from the first terminal 11 is address information of a number of terminals, the PoC server 44 connects the first terminal 11 to the number of called terminals over one talk session.

On the other hand, when the second terminal 12 logs in and is busy or logs out, the second proxy server 41 transmits a virtual response message to the PoC server 44 (S10).

In this case, the second proxy server 41′ may transmit a 4xx′ message as the virtual response message to the PoC server 44.

When the message processor 44a of the PoC server 44 receives the 4xx′ as the virtual response message from the second proxy server 41′, the message processor 44a transmits, to the SMS system 50, an SMS request message based on the unique ID information assigned to the talk session, which is established in response to the ‘INVITE’ message received from the first terminal 11, and on the CDMA network ID information of the second terminal 12 (S11).

The PoC server 44 assigns the unique ID information to respective talk sessions established in response to the received ‘INVITE’ message, and stores and manages address information of the called terminal to which the SMS request message is sent and unique information of a talk session in which the called terminal will participate.

The SMS server 51 of the SMS system 50 generates a short message based on the ID information of the talk session included in the SMS request message from the PTT system 50 and CDMA network ID information of the second terminal 12, and transmits the short message to the message transmitter 52.

The message transmitter 52 transmits the short message from the SMS server 51 to the second terminal 12 as the called terminal over the mobile communication network (S12).

In this case, when there are a number of called terminals in a log-out state or in a busy state, the message processor 44a of the PTT system 40 may transmit different SMS request messages based on the address information of the number of called terminals and the talk session ID information or transmit the SMS request messages according to address information grouping the address information of the number of called terminals and the ID information of the talk session.

The SMS server 51 may generate a number of short messages in response to the different SMS request messages or generate one short message based on ID information of the same talk session and transmit it as address information of a group of called terminals.

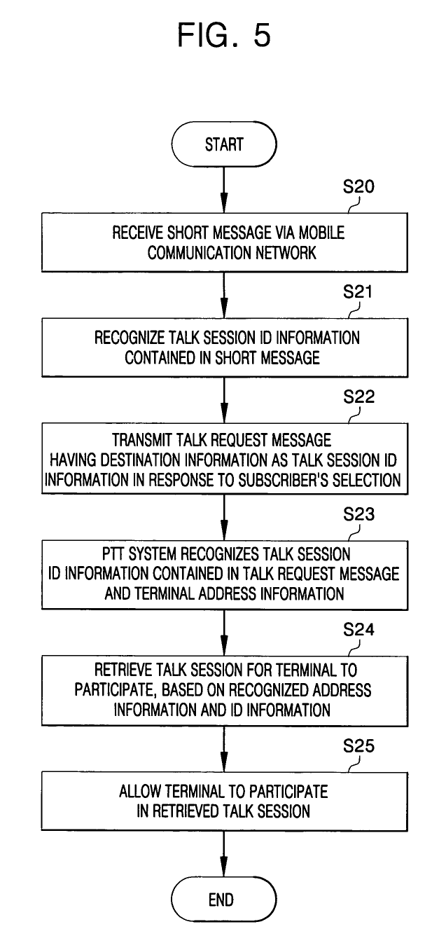

FIG. 5 is a flowchart illustrating a method by which a terminal participates in a talk session according to an embodiment of the present invention.

Referring to FIG. 5, when the PTT system 40 receives a talk request message to establish a talk session with the terminal 10 from another terminal while the terminal 10 does not log in the PTT system 40 or is in a busy state, the PTT system 40 transmits a short message containing ID information of the talk session to the terminal 10 via the SMS system 50.

In the terminal 10, the communication network interface 10a receives the short message via the mobile communication network (S20).

The communication network interface 10a of terminal 10 provides the short message, which is received via the mobile communication network, to the central controller 10e and recognizes the talk session ID information contained in the short message (S21).

The central controller 10e provides a display signal based on short information in the short message to the display device 10d, recognizes the talk session ID information, and stores the talk session ID information in the storage unit 10f.

The central controller 10e outputs visual and or audible information from which the subscriber is able to recognize the received short message.

When the subscriber wants to participate in the established talk session via the PTT system 40 in response to the received short message, he or she preferably selects a preset key on the key pad 10c and the key pad 10c provides the key signal to the central controller 10e.

The talk processor 10g of the central controller 10e generates an ‘INVITE’ message as a talk request message in response to the key signal received from the key pad 10c and transmits the ‘INVITE’ message to the proxy server 41 (S22).

In this case, the talk processor 10g generates the ‘INVITE’ message containing the talk session ID information from the storage unit 10f as the destination information, and transmits the ‘INVITE’ message to the proxy server 41 connected to the network via the wireless interface 10b.

The proxy server 41 transmits the ‘INVITE’ message from the terminal 10 to the PoC server 44, and the PoC server 44 recognizes talk session ID information contained in the talk request message as destination information in the received ‘INVITE’ message, and the terminal address information (S23).

The PoC server 44 stores and manages address information of a terminal transmitting the short message via the SMS system 50 and ID information of a talk session in which the terminal has to participate, and retrieves the talk session for the terminal 10 to participate, based on the address information of the terminal 10 transmitting the ‘INVITE’ message (S24).

The PoC server 44 allows the terminal 10 to participate in the retrieved talk session (S25).

That is, when the PoC server 44 of the PTT system 40 transmits the short message, it stores address information of the terminal 10 in a list. When the address information of the terminal 10 transmitting the ‘INVITE’ message is included in the list, the PoC server 44 allows the terminal to participate in a talk session corresponding to the talk session ID information, which is included as the destination information in the ‘INVITE’ message.

Accordingly, the PTT system 40 does not confirm preset approval information and allows the terminal 10 to participate in the talk session according to the destination information in the ‘INVITE’ message when the terminal 10 is included in the list of the terminal 10 transmitting the short message, minimizing the time needed to participate in the talk session.

That is, upon receipt of the ‘INVITE’ message, the PTT system 40 allows the terminal transmitting the ‘INVITE’ message to participate in the talk session when the terminal is included in the short-message transmission list without requesting the GLMS 43 to send incoming information to check whether the approval information from the called terminal is set as partial-approval information or overall-refusal information.

As described above, in the PTT service providing system according to embodiments of the present invention, even when the called terminal receiving a talk request message from a calling terminal is in a log-out state or in a busy state, a short message is transmitted to the called terminal to indicate that the talk request message is received, such that the called terminal participates in a pre-established talk session on the PTT system through the short message.

The PTT system also stores address information of the called terminal to which the short message is sent and unique information of an established talk session, and allows the called terminal to participate in the pre-established talk session without confirming whether participation in the talk session is approved based on address information of a terminal transmitting the talk request message and destination information, thereby minimizing the time needed for the subscriber to participate in the talk session.

While the present invention has been described with reference to exemplary embodiments thereof, it will be understood by those skilled in the art that various changes in form and detail may be made therein without departing from the scope of the present invention as defined by the following claims.

1. A system for providing a push to talk (PTT) service, comprising:
a PTT system for managing a connection state of at least one terminal connected to the PTT system, establishing a talk session based on destination information in a talk request message received from a first terminal, and providing a short message service (SMS) request message according to unique information of a second terminal participating in the talk session and unique information of the talk session when the second terminal is in a log-out state or a busy-state; and
an SMS system for transmitting a short message to the second called terminal, the short message including the unique information of the talk session in the SMS request message received from the PTT system.

2. The system according to claim 1, wherein the PTT system sets reception states of the respective terminals and transmits the SMS request message to the SMS system when the second terminal is set as a receivable state.

3. The system according to claim 1, wherein the PTT system stores the unique information assigned to the established talk session and unique information of the respective terminals participating in the talk session, and allows the calling terminal to participate in a talk session corresponding to unique calling information in the received talk request message.

4. The system according to claim 1, wherein each terminal transmits the talk request message to the PTT system in response to a subscriber's selection, the talk request message including the unique information of the talk session, which is recognized from the short message received from the SMS system, the unique information being set as destination information.

5. The system according to claim 1, wherein the unique information of the respective terminals is mobile communication network ID information assigned to the respective terminals in a mobile communication network.

6. A push to talk (PTT) system for providing a PTT service to at least one terminal, the system comprising:
a first server for managing information regarding connection states of the respective terminals connecting to the first server over an access network;
at least one second server for receiving a talk request message from each of the terminals, confirming a connection state of a called terminal through the first server in response to the talk request message, and then transmitting a virtual response message according to the connection state of the called terminal,
a third server for managing address information of the respective terminals connecting to the second server for each list or group and managing information about whether the talk request message from each terminal is accepted; and
a fourth server for establishing a talk session in response to the talk request message received via the second server, and when the virtual response message is received from the second server, requesting a short message server to transmit a short message including unique information of the talk session, based on the address information of the called terminal managed by the third server and the information about whether the talk request message is accepted.

7. The system according to claim 6, wherein the connection state information is at least one of log-in state information, log-out state information, and busy-state information.

8. The system according to claim 6, wherein the fourth server comprises a message processor for managing the address information of the respective terminals and the unique information of the talk session and allowing the respective terminals to participate in the talk session according to destination information and calling address information in the received talk request message.

9. A terminal for receiving a push to talk (PTT) service, the terminal comprising:
a communication network interface for receiving a short message via a mobile communication network;
a wireless interface for receiving a talk request message via an access network or wirelessly transmitting a talk request message generated by the terminal; and
a talk processor for recognizing unique information of a talk session included in the short message received by the communication network interface, and generating a talk request message including the unique information as destination information to transmit the talk request message to the access network via the wireless interface according to a subscriber's selection.

10. A method for providing a push to talk (PTT) service in a PTT service providing system having at least one terminal, a PTT system and a short message service (SMS) system, the method comprising the steps of:
managing, by the PTT system, connection states of respective terminals connecting to the PTT system over a network;
establishing, by the PTT system, a talk session having unique information assigned thereto in response to a received talk request message from each of the terminals, and confirming a connection state of a called terminal based on called information in the talk request message;
transmitting, by the PTT system, an SMS request message to the SMS system according to unique information of the talk session and address information of the called terminal when the called terminal is in a log-out state or a busy-state;
transmitting, by the SMS system, a short message containing the unique information to the called terminal in response to the SMS request message;
transmitting, by the called terminal, a talk request message having the unique information, contained in the short message, set as destination information to the PTT system in response to a subscriber's selection; and allowing, by the PTT system, the called terminal to participate in a talk session based on unique information set as destination information in the talk request message.

11. The method according to claim 10, wherein the step of transmitting the SMS request message comprises the steps of:
confirming, by the PTT system, message acceptance information for the respective terminals; and
transmitting, by the PTT system, the SMS request message when the message acceptance information of the called terminal is set as a receivable state, and performing reception failure processing when it is set as an acceptance refusal state.

12. A method of providing a push to talk (PTT) service in a PTT system connected to at least one terminal, comprising the steps of:
managing connection states of the respective terminals connecting over an access network;
establishing a talk session having unique information assigned thereto in response to a received talk request message from a first terminal;
confirming a connection state of a second terminal, and transmitting a short message based on the unique information and address information of the second terminal to the second terminal via a short message server when the connection state is service unavailable;
storing unique information of the talk session and address information of respective terminals that will participate in the talk session; and
when calling address information in the talk request message received from the second terminal is retrieved from stored terminal address information, allowing the second terminal to participate in a talk session corresponding to the address information.

13. A method of providing a push to talk (PTT) service in a terminal, the method comprising the steps of:
recognizing unique information of a talk session that is contained in a short message received from a mobile communication network;
generating a talk request message having the unique information set as destination information in response to a subscriber's selection;
transmitting the talk request message to a PTT system over an access network; and
providing the PTT service to the subscriber over a talk session, participation in the talk session being made by the PTT system based on unique information in the talk request message.
